(19) United States
(12) Patent Application Publication
(10) Pub. No.: US 2020/0101636 A1
(43) Pub. Date: Apr. 2, 2020

(54) METHOD FOR PRODUCING A HYDROPHOBIC ELEMENT AND USE THEREOF

(71) Applicant: CELLOZ, Paris (FR)

(72) Inventor: François RUFFENACH, Levallois-Perret (FR)

(21) Appl. No.: 16/484,522

(22) PCT Filed: Feb. 13, 2018
(86) PCT No.: PCT/FR2018/050342

§ 371 Date: Aug. 8, 2019

(30) Foreign Application Priority Data
Feb. 14, 2017 (FR) 1751177
Feb. 14, 2017 (FR) 1751187

(51) Int. Cl. B27N 1/00; B27N 3/00; B27N 3/18; B27N 7/00; B27K 3/50; E04D 1/26; E04D 3/32; B27K 3/02

(52) U.S. Cl. CPC B27N 1/006; B27N 3/002; B27N 3/18; B27N 7/005; B27K 2240/70; E04D 1/26; E04D 3/32; B27K 3/0214; B27K 3/50

(57) ABSTRACT

A method for producing a hydrophobic element is disclosed and includes the following steps: a) preparing a mixture of water and an organic material from sustainably renewable resources, b) moulding the mixture prepared in step a) to obtain a moulded element, c) drying and densifying the moulded element obtained in step b) to obtain a dried and densified element-, and d) impregnating to the core the dried and densified element obtained in step c) with a binder composed of organic materials from sustainably renewable resources. A covering hydrophobic element containing more than 90%, and preferably more than 99%, of an organic material from sustainably renewable resources is also disclosed.

### TECHNICAL FIELD OF THE INVENTION

The invention aims to manufacture a hydrophobic covering element from biosourced materials, and more particularly from organic materials coming from the resources that are sustainably renewable.

“Biosourced material” means a material coming from plant or animal biomass.

“Organic materials coming from sustainably renewable resources” means all of the chemical compounds formed by organic molecules found in the natural environments, of terrestrial or marine origin, and the stock of which can be replenished over a short period on the human time scale, by being renewed at least as fast as it is consumed, for example the various livestock or crop resources (biomass).

The covering element can be used to cover at least a portion of an inner surface, like a wall and/or a ceiling, or a surface in contact with the outside, such as roofing or cladding, in order to protect this surface from humidity or from inclement weather.

The covering element can be used as a finishing element and can be used in the field of decoration.

### PRIOR ART

In general, wall-finishing products, substantially consisting of organic material coming from the resources that are sustainably renewable, are mainly wallpapers consisting of a very fine layer of cellulose with or without coating by a layer of often expanded synthetic materials, the total thickness of which is less than 3 mm. These products are presented in the form of a roll. They are applied onto a wall in successive lengths and pasted over their entire surface.

Alternatively, it is known to use covering elements having a relief, they generally consist of agglomerated wood fibres of the MDF type glued with a synthetic resin, of polystyrene foam or of cork. Each of these materials has its own method. These elements are presented in the form of panels ranging from several millimetres to several centimetres thick.

None of these products of the prior art can preserve its initial shape in the face of time and humidity or allow to ensure durable impermeability of the surface onto which they are applied.

With regard to the covering of surfaces in contact with the outside, there are roof-covering elements made of cellulose impregnated with bitumen or thermosetting resins, such as plates, implemented while respecting longitudinal and transverse overlapping between them in order to ensure the impermeability of the roof, and with accessories such as ridge tile, flashing or bargeboard, connected to these elements and capable of covering special points in the roofing.

The bitumen and the thermosetting resins come from fossil resources, the use of which has a negative effect on the environment and on humans.

None of the current products allow to simultaneously meet all of the required needs, namely ensuring impermeability without being harmful to the environment and to humans.

### OBJECT OF THE INVENTION

The present invention aims to overcome all or a portion of the disadvantages of the prior art mentioned above by proposing a method for manufacturing a hydrophobic covering element, and a hydrophobic covering element, mainly or entirely coming from sustainably renewable resources, thus falling within the criteria of sustainable development and safety for humans and the environment while remaining economical, and allowing to ensure the impermeability of the surface that it covers.

According to the invention, the covering and/or the finish of the surface are made from a covering element manufactured exclusively or almost exclusively from materials coming from the resources that are sustainably renewable. The covering element according to the invention participates in the impermeability of the surfaces and allows to prevent the risks of fire, insulate from noise or from the cold etc.

For this purpose, the present invention is aimed at a method for manufacturing a hydrophobic covering element, characterised in that it comprises the following steps:
a) Preparation of a mixture of water and of organic material coming from sustainably renewable resources,
b) Moulding of the mixture prepared in step a) in order to obtain a moulded element,
c) Drying and densification of the moulded element obtained in step b) in order to obtain a dried and densified element,
d) Full impregnation of the dried and densified element obtained in step c), in a binder composed of organic materials coming from the resources that are sustainably renewable in order to obtain a hydrophobic covering element.

“Binder” means one or more organic materials coming from sustainably renewable resources capable of ensuring the cohesion of the fibres of the moulded element and particularly effective in a humid environment, substantially because of its rheological properties.

The hydrophobic element obtained by this method thus comes entirely from sustainably renewable resources.

According to one feature, the organic matter used in step a) is non-soluble in water and can be dispersed with stirring in order to be in suspension in the water. It ideally comprises molecules with a size greater than 1 micrometre. The organic matter used in step a) can be chosen from the group comprising, in a non-exhaustive manner:
cellulose or hemicellulose extracted from the plant fibres, coming for example from wood, from cotton, from hemp, from jute, from flax, from bamboo, from abaca, from coconut, from sisal, from grass and other Gramineae, from algae, from mushrooms,
press cakes of oleaginous plants or oleaginous plants such as rapeseed, sunflower, flax, soybean, castor bean, peanut, sesame, cotton, Crambe, hemp, Jatropha and/or neem,
waste from the agri-food industry or from agriculture such as cereal waste and namely stems and pods or husks of corn, of wheat, of bran, of common wheat, of rye, of rice or waste from the fish industry, materials coming from the grinding of the stones or shells of the fruits such as the olive, plums, walnuts, pistachios, peanuts, cocoa beans, apples seeds,
chips or sawdust of wood,
a mixture of these organic materials.

Advantageously, the organic material used in step a) is cellulose fibre, preferably coming from recycled paper.

In order to advance further in terms of the environmental aspect and actively participate in a strong approach of sustainable development expected through the new international legislation, the present invention endeavours to limit the use of the fibres of celluloses coming directly from wood by the use of the fibres coming from recycled paper thus providing a second life to these materials.

Alternatively, the organic material used in step a) is a mixture comprising at least one of the aforementioned organic materials and:
vegetable proteins, such as albumin, globulin, prolamin, glutelin, casein, collagen and/or keratin,
plant fibres of any size and namely of a very small size of less than 5 micrometres like micro fibrils of cellulose or nano fibrils of cellulose or nanocrystalline cellulose,
biosynthesised polymers like lignin,
tannins,
polymer compounds chosen from the group formed by the polysaccharides, the polypeptides and galactoses such as pectins, pectic substances, agar-agar, chitin and/or chitosan, gum arabic, or coming from the fermentation of the sugars of the plants such as polylactic acid and its derivatives or the family of the polyhydroxyalkanoate (PHA, PHB, PHBV . . . ), or from a chemical reaction with a reactant such as the ester of cellulose,
cereal flours, beetroot pulp and/or flours of protein crops,
keratin coming from sheep, goat, rabbit, llama, alpine pasture, guanaco, camel and/or yak wool, or from chicken, duck and/or goose feathers, or from mammal hoof or horn,
a mixture of these elements.

Advantageously, the chitin comes from the mushrooms, the crustaceans or the insects.

Alternatively, pigments of mineral or organic origin ideally coming from renewable materials are added in step a) in proportions of between 0.1 and 10% of the total mass of dry organic materials in step a).

The quantity of water in the mixture of step a) is preferably greater than the quantity of organic material, the quantity of organic material being advantageously between 1 and 20%.

Advantageously, all or a portion of these organic materials coming from the resources that are sustainably renewable can undergo, or have previously undergone a mechanical treatment of the refining type allowing to increase the number of physical bonds between them and thus reinforcing the performance of the hydrophobic element.

According to one feature, the moulded element at the output of step b) contains between 20 and 35% organic materials and between 80 and 65% water. These compositions depend mainly on the type of organic materials used, on the initial concentration of organic material in the mixture prepared in step a), on the duration of moulding, on the temperature of the water and on the moulding method used.

The step b) of moulding is advantageously carried out according to a method for vacuum forming.

This method involves creating a depression inside a mould called forming mould immersed in the mixture prepared in step a), said forming mould comprising orifices having a size preferably between 0.5 and 15 mm, and more preferably from 5 to 10 mm, and being lined with a fine wire mesh, the mesh of which is smaller than said orifices.

Thus, the mixture prepared in step a) is transferred and filtered on the surface of the metal sheet and the water is evacuated through the orifices of the mould.

The forming mould is advantageously metal or made of synthetic material resistant to water and to temperatures of up to 75° C.

The forming mould is maintained in the mixture prepared in step a) for a time of between 0.5 and 10 seconds, according to the initial concentration of organic material and the thickness and the desired weight for the element to be manufactured.

In one embodiment of the invention, the step b) of moulding is carried out via a drum preferably with four faces, comprising at least one forming mould on each of these faces, the moulds being preferably identical to each other, the drum rotating by a predetermined time sequence in such a way that each forming mould is immersed in the mixture prepared in step a).

According to embodiments, the step c) of drying and densification is carried out by a pressing system comprising at least a pressing mould and counter-mould pair.

Densification means the compacting of the moulded element by pressing as the water is extracted.

Thus, the step c) of drying and densification can be carried out by a pressing system comprising at least one mould and at least one pressing counter-mould.

According to embodiments, the mould and counter-mould pair is placed under a depression, while being heated, and the mould and counter-mould are pressed against one another.

Each pressing mould and counter-mould comprises orifices of a size preferably between 3 and 10 mm.

These orifices are advantageously closed by nozzles with slots or holes in such a way that only the water can be evacuated through them.

The element moulded in step b) is transferred into said pressing system, each mould and counter-mould of the pressing system being placed under a depression, under vacuum, while being heated to a temperature preferably between 160 and 280° C., in order to evacuate the water contained in the moulded element, and preferably between 200 and 280° C.

The pressure applied between each mould and counter-mould during the pressing against one another is preferably between 3 and 50 bar, and more preferably between 3 and 10 bar, in order to densify the moulded element.

The temperature and the pressure are dependent on the quantity or on the thickness of the element moulded in step b), in order to not deteriorate the organic material.

Advantageously, the temperature of each pressing mould and counter-mould is approximately 180° C. for thicknesses of the moulded element of approximately 1 mm and is approximately 200° C. and preferably 220° for thicknesses of the moulded element of approximately 2 mm and is approximately 280° C. for thicknesses of the moulded element of approximately 3 mm.

If a polymerised organic material such as polylactic acid is present in the element moulded in step b), the temperature of the moulds and counter-moulds must be adapted in such a way that it is greater by at least several degrees than the temperature of the melting point of said polymer.

According to one feature, the pressing system comprises a plurality of pressing moulds and counter-moulds.

The temperature of each pressing mould and counter-mould is advantageously identical.

Alternatively, the temperature of each pressing mould and counter-mould is independently adjustable, in such a way that the drying can follow a temperature profile according to the quantity of water remaining to be removed, thus preserving the organic material and allowing to optimise the electricity consumption.

The pressure applied to each pressing mould and counter-mould is advantageously independently adjustable.

Each pressing mould and counter-mould is preferably metal and resistant to heat.

In one embodiment according to which the pressing system comprises a plurality of pressing moulds and/or a plurality of pressing counter-moulds, said moulds are disposed in a horizontally aligned manner and said counter-moulds are disposed above, also in a horizontally aligned manner. This is called a rectilinear system.

According to this embodiment, the pressing moulds are mobile vertically in the direction of the pressing counter-moulds, and the pressing counter-moulds are mobile horizontally in order to move the moulded element from one pressing mould to another.

According to one feature, the pressing system comprises two pressing moulds and three pressing counter-moulds.

In another embodiment according to which the pressing system comprises a plurality of pressing moulds and a plurality of pressing counter-moulds, the pressing moulds and counter-moulds are disposed in a circle and capable of moving by rotation of said circle. This is called a carrousel system.

In this embodiment, each counter-mould is located above and vertically in line with a mould, in such a way as to form mould and counter-mould pairs.

The mould and counter-mould of a pair move together.

The pressing system thus comprises a plurality of pressing mould and counter-mould pairs, the pairs being disposed in a circle and capable of moving by rotation of said circle.

Step c) comprises a series of steps of drying and densification between a pressing mould and counter-mould.

In the carrousel system, the element moulded in step b) is dried and densified in a single pressing mould and counter-mould pair, over the duration of rotation of said carrousel.

The system called carrousel allows to limit the lost time during which no action of pressing and drying is carried out and which corresponds to the time at which the vacuum and the pressure are stopped and at which the transfers are carried out. This loss of time of treatment of the material is advantageously reduced via this carrousel assembly. With an equivalent number of mould and counter-mould, the circular transfer system allows to increase the productivity by addition to the rectilinear system.

The element moulded in step b) is advantageously transferred into the pressing system via a counter-mould, called transfer counter-mould.

According to embodiments, step c) comprises an additional drying in a hot air or infrared or microwave or high-frequency oven.

This additional drying is optionally continuous, the element moulded in step b) being transported on a conveyor entering and exiting on either side of the oven.

The additional drying allows to improve the productivity by thus maximising the production volume of a manufacturing unit.

The drying temperature is adjustable in such a way that the drying can be adapted to the quantity of water to be extracted according to parameters measured in line and to the weight of the element to be obtained.

This additional drying is advantageously carried out before the step c) of drying, for elements moulded in step b) comprising between 80 and 50% water, in order to evacuate a certain quantity of water and raise the temperature of the water remaining in the moulded element.

Alternatively, this additional drying is carried out after a first step of drying and densification of the moulded element, by a first mould and counter-mould pair.

Step c) advantageously comprises a final step of drying of the element, carried out in a hot air or infrared or microwave or high-frequency oven.

Alternatively the final step of drying of the element is carried out by drying between a mould and a counter-mould with a previous step of humification by spraying of water onto the two faces of the element.

The final drying step allows to bring the quantity of organic matter to between 75 and 100%.

Step c) is thus carried out via a system of pressing and heating moulds and counter-moulds ensuring the sequential rectilinear or circular transfer of the element with adjustable pressures and temperatures or by a combination of this system with one or more additional dryings using hot air or infrared or microwaves or high frequency.

The full impregnation (step d)) involves immersing the dried and densified element obtained in step c) in the binder composed of organic materials coming from the resources that are sustainably renewable, at a temperature advantageously between 150 and 220° C., and preferably between 170 and 190° C. Thus the viscosity of the binder is reduced in such a way that it can correctly impregnate the element obtained in step c). The viscosity of the binder is advantageously less than 500 MPa at a temperature of 160° C.

The softening temperature of the binder, as defined by the French standard NF EN 1427, is between 10 and 150° C. or advantageously between 20 and 80° C., and preferably 45° C.

According to one feature, the organic material of the binder can be:
residues coming from the processes of decomposition of wood, in particular the conifers by the Kraft process, such as crude Tall-oil, Tall-oil pitch, the fatty acids of Tall-oil and their derivatives, the resins of Tall-oil and their derivatives, the resins of rosin and their derivatives,
lipids like the preferably unsaturated fatty acids and more generally vegetable or animal oils, like the oil of castor bean, of tung, of flax, castor oil,
polymer compounds chosen from the group formed by the polysaccharides, the polypeptides and galactoses such as pectins, pectic substances, agar-agar, chitin and/or chitosan, gum arabic, the tannins or coming from the fermentation of the sugars of the plants such as polylactic acid and its derivatives or the family of the polyhydroxyalkanoate (PHA, PHB, PHBV . . . ), or from a chemical reaction with a reactant such as the ester of cellulose,
a mixture of a plurality of these organic materials.

Advantageously, the chitin comes from the mushrooms, the crustaceans or the insects.

Alternatively, the organic material of the binder is a mixture comprising at least one of the organic materials mentioned above, called main organic material, and of other organic materials coming from the resources that are sustainably renewable, called secondary, such as:
resins of rosin and their derivatives, the terpene phenolic resins, the resins of fatty acid,
resins of Tall-oil and their derivatives
biosynthesised polymers coming from renewable resources such as lignins, PLA polylactic acid and its derivatives or the family of the polyhydroxyalkanoate (PHA, PHB, PHBV . . . ),
stand oils of vegetable oil,
phospholipids like lecithin,
natural waxes,
gum resins.

The binder comprises between 20 and 100%, preferably between 50 and 100%, and more preferably between 65 and 95% or between 80 and 100%, main organic material by mass. As a reminder, this main organic material comes from sustainably renewable resources.

According to the formulation, the binder can advantageously contain an antioxidant agent and/or a drying agent, between 0.1% and 5% of the binder by mass.

According to embodiments, the binder consists of an organic material, coming from the resources that are sustainably renewable, in liquid form between 20 and 150° C. or of a mixture of organic materials coming from the resources that are sustainably renewable, the mixture being in liquid form between 20 and 150° C.

In general, the composition of the binder depends on the type of exposure to which the hydrophobic element will be subjected in order for the performance of the latter to be maintained, for example in a cold, temperate, hot, or tropical climate.

Tall-oil and its derivatives are residues from the treatment of the conifers during the manufacture of the papers according to the Kraft process.

The derivatives of Tall-oil are for example the non-volatile residues, called Tall-oil pitch, obtained after saponification and acidification of the Tall-oil. According to embodiments, the binder is a plant binder composed of derivatives of Tall-oil, such as Tall-oil pitch.

The lignins advantageously come from the paper process using sulphate (Kraft lignin) or using sulphite (lignosulphonate).

The rosin resin and the terpenes are obtained from the plant resin extracted from the resin-producing trees by the tapping operation (incision under the bark of the tree allowing the resin to flow) or from the residues coming from the manufacture of the papers according to the Kraft process.

As a preferred example, the binder comprises 75% Tall-oil pitch by mass, 15% terpene phenolic resin and 10% additives such as plant wax or linseed oil.

As another example, the binder comprises 49% terpene phenolic resin by mass, 49% low-viscosity esterified rosin resin and 2% antioxidant and tannins.

The binder is previously prepared by batch or continuously, preferably under an inert atmosphere.

The preparation of the binder involves heating the main organic material to a temperature of at least 150° C., and continuously mixing it with the secondary organic material heated to 150° C., in a static mixer.

One alternative involves mixing the main organic material, previously heated to 150° C., with the secondary organic material in a screw or paddle mixer heated to 150° C.

The binder thus obtained supplies the impregnation tank in a closed circuit.

The element obtained in step c) has a total quantity of materials of at least 97% in order to not cause an evaporation of water that is too great during its impregnation.

The duration, called duration of impregnation, is between 5 and 30 minutes, or between 10 and 30 minutes, and preferably between 10 and 20 minutes or 15 and 20 minutes. One alternative involves creating a vacuum in an impregnation tank containing the elements before immersing them in the binder then creating an overpressure during the impregnation in such a way as to accelerate the step of impregnation. Then the binder is progressively evacuated from the tank by a pumping system before removing the impregnated element therefrom.

Progressively means a regular linear speed of draining of the impregnation tank of less than 1 metre per minute, or advantageously of less than 30 cm per minute. The speed of the draining is the speed at which the element crosses the free surface of the binder.

Preferably, each element is stored upright in the impregnation tank, in such a way as to present its thickness to the free surface of the binder. Advantageously, the free surface of the binder follows the length of the element during the draining of the impregnation tank.

The invention falls within an approach of sustainable development by reusing the residues coming from the Kraft paper process.

According to embodiments, the manufacturing method comprises an additional step e), involving coating the hydrophobic element obtained in step d) with a coating.

Step e) is called finishing step.

The coating is one or more layers of a finishing material, like a paint, chosen from the group comprising materials containing mineral pigments and mineral fillers, biosourced organic pigments coming from the resources that are sustainably renewable materials containing plant resins coming from biomass, materials containing synthetic resins.

According to one feature, the coating comprises mineral pigments or organic pigments coming from renewable materials and mineral fillers.

According to another feature, the coating comprises organic resins coming from the resources that are sustainably renewable.

Alternatively, the coating comprises synthetic resins such as acrylic resins.

According to embodiments, a fireproofing and/or hydrophobic treatment is carried out in step a) and/or during step d) and/or during step e).

Thus, a fireproofing and/or hydrophobic treatment can be carried out in step a) and/or during the step of impregnation and/or during the finishing (step e) above). For this purpose, materials capable of conferring fireproofing and/or hydrophobic properties are added to these steps.

The invention further relates to a hydrophobic element for covering at least a portion of a surface, such as a wall and/or a ceiling and/or a surface in contact with the outside, said element having a developable or non-developable shape and comprising a back in contact with said surface and a visible front, characterised in that it comprises more than 90%, and preferably more than 99%, organic material coming from sustainably renewable resources.

The term “developable shape” means a shape that can be applied onto a plane in the sense of differential geometry. Thus, a developable shape can be deployed along a generatrix having the same plane tangent to the latter.

On the contrary, a developed shape is already thus deployed.

The hydrophobic covering element has a low impact on the environment; it has, because of its makeup, a low weight facilitating its implementation, a resistance to water and to thermal and mechanical stresses, as an element for covering a roof for example.

In the rest of the description, “hydrophobic element” means a hydrophobic covering element.

The hydrophobic element can take on a multitude of developable or non-developable shapes in order to adapt to the local architecture or propose innovative shapes.

It is important to note that a developable or non-developable shape is not related to a particular use or particular context of use of the element.

The hydrophobic element preferably has a non-developable shape.

The hydrophobic element is capable of covering a surface, like a wall, a ceiling or a roof.

According to embodiments the visible front is capable of having a relief with a decorative appearance.

Moreover, the visible front of the hydrophobic element can have varied appearances constituting decorative objects and shapes, like reliefs with multiple shapes capable of covering at least a portion of the surface of a wall, of a ceiling or of a roof.

According to embodiments, the hydrophobic element is adapted for resisting to climatic stresses such as the sun, wind, rain, snow, etc. This aspect is very advantageous for the covering of a surface in contact with the outside such as roofing.

In general, the hydrophobic element does not contain any bitumen or equivalent product.

According to one feature, the hydrophobic element is obtained according to the method described above.

Advantageously, the level of binder impregnation is between 30 and 60%, or 40 and 55%, and preferably between 45 and 50% according to the thickness and the density of the element.

The level of impregnation of the binder is defined as being the quantity of the binder divided by the quantity of the dried and densified element obtained in step c) plus the quantity of binder.

Advantageously, the level of materials, synthetic or coming from the resources that are sustainably renewable deposited as a coating during step e) represents less than 10% of the total quantity of the materials used to create the hydrophobic element.

The invention also relates to the use of a hydrophobic covering element for the covering of at least a portion of a surface in contact with the outside, such as roofing or cladding.

The invention also relates to the use of a hydrophobic covering element as a decorative object chosen in particular from the group comprising friezes, complaints, mouldings, decorative panels.

In embodiments, the hydrophobic element can also be used to camouflage cables or devices of alarms or of securities, such as sensors useful in the case of a break-in or fire. For this purpose, it can comprise, besides the reliefs on the front, housings on both the front and its back.

The hydrophobic element can thus be used as an element for covering roofing, a wall, a portico for example.

For example, the element is placed on a frame with a slope of at least 12° by spacing battens by 480 mm in such a way that each hydrophobic element is carried by three battens (one at each end and one at the centre of the hydrophobic element).

The fastening of the hydrophobic element is carried out with nails, such as nails with a plastic head, or screws such as screws with a plastic head. Advantageously, those are nails or screws with overmoulded heads.

A plurality of hydrophobic elements are positioned on a frame in such a way that they ensure the impermeability of the roofing.

Advantageously, there is an alternation between a whole hydrophobic element and a half of a hydrophobic element, in such a way that they are placed in staggered rows.

The hydrophobic element according to the invention can take on various shapes having a relief height ranging from several millimetres up to 20 centimetres and the thickness of which can be adapted according to its exposure to a risk of stress. The thickness can vary for example from 0.5 to 6 mm and the height of the relief from 1 to 200 mm.

For example, a hydrophobic element intended to be applied onto a ceiling will have a thickness for example of 1 mm whereas a hydrophobic element applied onto a wall and exposed to people passing by and to occasional impacts will have a greater thickness for example of 3 mm. The dimensions of the hydrophobic element depend on its use. In the case of a frieze or of a moulding, it can have a circular shape with a diameter ranging from several millimetres to for example 600 mm or a rectilinear shape with a length of several millimetres to for example 1000 mm and a width of several millimetres to for example 600 mm. In the case of a frieze or of a decorative panel, it can have various shapes but preferably rectangular and for example a dimension of 600×1000 mm. In this case it can cover the totality of a wall, each element being placed edge to edge.

The hydrophobic element can be applied onto the surface with a double-sided adhesive or with a coating glue on the back of the element or on the surface to be covered.

### BRIEF DESCRIPTION OF THE DRAWINGS

Other objects, features and advantages of the present invention will appear in the following description via examples that are only for informational purposes and in no way limiting to the scope of the invention, and on the basis of the appended illustrations in which:

FIG. 1 is a schematic front view illustrating the steps a) and b) of the method of the invention,

FIG. 2 is a schematic front view of a forming mould used during step b) of the method of the invention,

FIGS. 3 and 4 are diagrams illustrating alternatives of step b) of the method of the invention,

FIG. 5 is a diagram illustrating step c) of the method of the invention,

FIG. 6a is a schematic front view of a pressing mould used during step c) of the method of the invention,

FIG. 6b is a schematic top view of the mould of FIG. 6a.

FIG. 7 is a schematic perspective top view of an example of a hydrophobic element for covering roofing,

FIG. 8 is a schematic front view of an alternative of FIG. 7.

FIG. 9 shows an example of a hydrophobic element for covering a wall viewed from above.

FIG. 10 shows a wall being covered by hydrophobic elements of FIG. 9.

### DETAILED DESCRIPTION OF EMBODIMENTS OF THE INVENTION

In the rest of the description, the terms “horizontal”, “vertical”, “transverse” and “longitudinal”, should be understood as qualifying elements resting in a fixed manner in parallel to the ground.

The method of the invention comprises the following steps:
a) Preparation of a mixture of water and of organic material coming from the resources that are sustainably renewable,
b) Moulding of the mixture prepared in step a) in order to obtain a moulded element,
c) Drying and densification of the moulded element obtained in step b) in order to obtain a dried and densified element,
d) Full impregnation of the dried and densified element obtained in step c) in a binder composed of organic materials coming from the resources that are sustainably renewable.

The method of the invention allows to obtain a hydrophobic element.

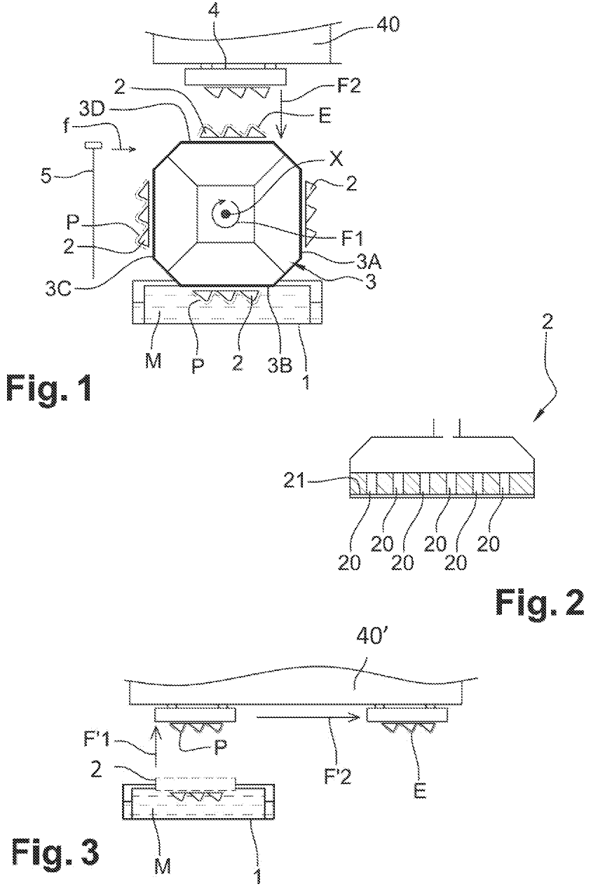

The steps a) and b) of preparing a mixture M of water and of cellulose fibres, and of moulding said mixture are illustrated in FIG. 1.

A mixture M of water and of 1 to 20% cellulose fibres is prepared in a tank 1 at a temperature between 10 and 75° C. and preferably between 35 and 45° C.

A mould, called forming mould 2 (shown in more detail in FIG. 2) is then immersed, under vacuum, in the tank 1 containing the mixture M, in such a way that a portion P of the mixture M is transferred onto said mould.

The forming mould 2 is disposed on a drum or shaft 3 having four faces 3A, 3B, 3C, 3D, each comprising a mould 2.

The drum 3 thus successively carries out rotations of 90° about a central axis X in such a way that each mould of each face 3A, 3B, 3C, 3D is immersed in the tank 1 containing the mixture M.

The speed of rotation of the drum 3 is approximately 1.5 to 30 rpm.

The portion P of the mixture M transferred onto the surface of each mould 2 is thus moulded under vacuum, in such a way as to obtain a moulded element E.

The moulded element E is then transferred onto the surface of a transfer counter-mould 4, under vacuum, disposed on a plate 40 above the drum 3.

This step of transfer of the moulded element E is possible via the creation of an overpressure (stoppage of the vacuum) in the mould 2 comprising the moulded element E, and of a depression (vacuum) in the transfer counter-mould 4.

More precisely, the moulding step involves:
Immersing the face 3A of the drum 3, comprising a mould 2, in the tank 1 comprising the mixture M, in such a way as to transfer a portion P of the mixture M onto the surface of the mould 2, via a first rotation of the drum 3 by 90° in the clockwise direction, according to the arrow F1,
After a time of between 0.5 and 10 seconds, carrying out a second rotation of the drum 3 by 90° in the clockwise direction, according to the arrow F1, in such a way that the face 3A is located perpendicularly to the tank 1, outside of said tank,
Applying a cloth, called moulding cloth 5, onto the portion P of the mixture M, for a time of between 0.5 and 10 seconds, in order to increase the effect of suction in the mould 2 and obtain the moulded element E, said cloth carrying out a movement of horizontal translation in the direction of the mould 2 in the direction of the arrow f,
Carrying out a third rotation of the drum 3 by 90° in the clockwise direction, according to the arrow F1, in such a way that the face 3A, and the moulded element E, are located in parallel to the transfer counter-mould 4,
Lowering the transfer counter-mould 4 onto the moulded element E, according to the arrow F2,
Creating a depression in the mould 2 and raising the transfer counter-mould 4 in such a way that the moulded element E is disposed on the surface of said counter-mould.

Thus, the mould 2 of the face 3A is empty.

A fourth rotation of the drum 3 by 90° in the clockwise direction allows to position the face 3A perpendicularly to the tank 1, then the steps described above are repeated in such a way as to mould a plurality of elements E.

The vacuum created inside the mould 2 allows to maintain the portion P of the mixture M on the surface of the mould 2.

When the transfer counter-mould 4 is lowered against the mould 2, the moulded element E is smoothed and densified.

FIG. 2 shows that each mould 2 comprises orifices 20 and is lined with a wire mesh, called bottom mesh 21.

The orifices 20 have a thickness of between 3 and 10 mm.

The bottom mesh 21 comprises a mesh having a size smaller than the orifices 20.

In a second embodiment, illustrated in FIG. 3, a mould 2 is immersed, under vacuum, in the tank 1 comprising the mixture M, then the mould 2, comprising a portion P of the mixture M, carries out a movement of vertical translation according to the arrow F′1 in order to remove the mould 2 from the tank 1.

Then, the mould 2 carries out a movement of horizontal translation in the direction of a belt conveyor (not shown), according to the arrow F′2, until a moulded element E is obtained.

The moulded element E is then deposited on the belt conveyor (not shown), after creation of an overpressure (stoppage of the vacuum) in the mould 2.

The mould 2 is suspended from a plate 40′, by elements allowing its vertical and horizontal movement.

The belt conveyor allows to move the moulded element E in the direction of a pressing system 6 (FIG. 5).

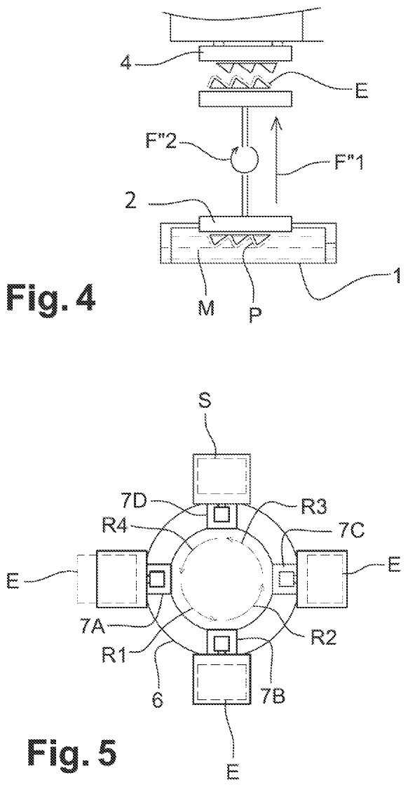

In a third embodiment illustrated in FIG. 4, a mould 2 is immersed, under vacuum, in the tank 1 comprising the mixture M, then the mould 2 carries out a movement of vertical translation according to the arrow F″1 and a movement of rotation of 180° according to the arrow F″2, in such a way as to present the moulded element E opposite a transfer counter-mould 4 as described with regard to FIG. 1.

The transfer of the moulded element E from the forming mould 2 to the transfer counter-mould 4 takes place in the same way as above, in the first embodiment.

FIG. 5 shows that the moulded element E is transferred to a carrousel pressing system 6.

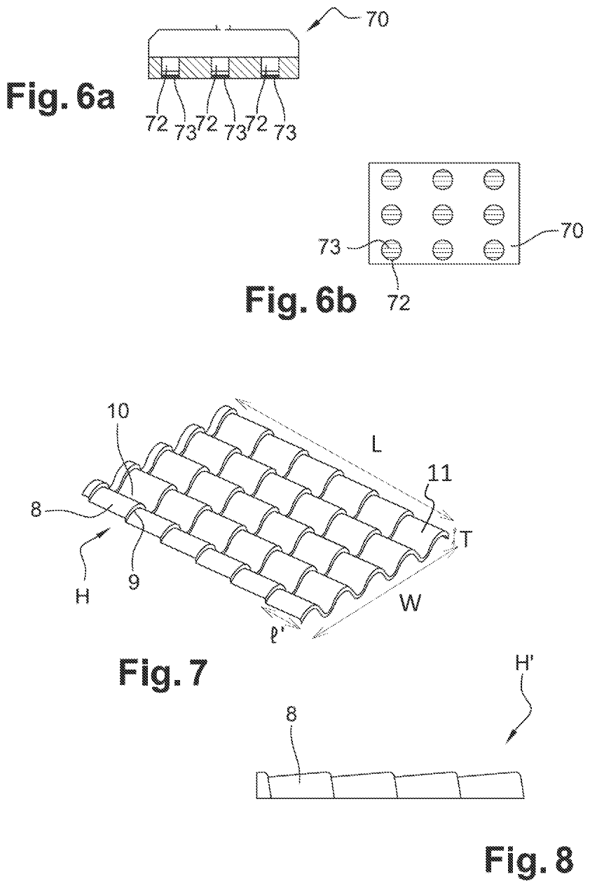

The carrousel pressing system 6 comprises four pressing mould 70 (FIGS. 6a, 6b) and counter-mould (not shown) pairs 7A, 7B, 7C, 7D.

More precisely, the moulded element E is transferred into a first pressing mould and counter-mould pair 7A in which the mould and counter-mould are pressed against one another, under vacuum, the mould and counter-mould being heated to a temperature of between 160 and 280° C.

The carrousel pressing system 6 then carries out a succession of rotation by 90° in the anti-clockwise direction, arrows R1, R2, R3, R4, in such a way that each pair 7A, 7B, 7C, 7D can receive a moulded element E.

When the pair 7A has carried out three rotations of 90°, a dried and densified element S is obtained.

The mould and counter-mould of the pair 7A move apart from one another and the dried and densified element S is transferred to the step of impregnation (not shown).

As shown in FIGS. 6a and 6b, each pressing mould 70 comprises orifices 72 having a size preferably between 3 and 10 mm.

These orifices 72 are closed by nozzles 73 with slots or holes.

Each counter-mould also has orifices and nozzles.

In the context of construction, the invention will be more particularly described with regard to a hydrophobic covering element for roofing, or a hydrophobic element for covering roofing, without being limited to such a use.

“Covering element for roofing” means an element capable of covering at least a portion of the surface of a roof.

In the rest of the description, the term “element for covering roofing” designates both the main covering elements for roofing, such as the plates or tiles, and the accessories, such as ridge tile, flashing or bargeboard.

FIG. 7 shows an example of a hydrophobic element H obtained after the step of impregnation (not shown).

The hydrophobic element H is intended for a use in roofing.

It is in the form of a corrugated plate, with a visible front 11 and an opposite back. The plate is substantially parallelepipedic, with a length “L” equal to 1020 mm, a width “W” equal to 665 mm, a thickness “T” equal to 2.5 mm and a non-developable shape.

In its length “L”, it comprises six rows of five tiles 8. The tiles 8 being parallel to each other, and the longitudinal direction of a tile 8 being identical to the longitudinal direction of the hydrophobic element H.

Each row of tile 8 is separated by an offset 9 and the tiles 8 of the same row are connected to each other by a groove 10.

Each tile 8 has a length “L′” of 160 mm.

FIG. 8 shows an alternative H′ of the hydrophobic element H of FIG. 7.

In this alternative, the hydrophobic element H′ is intended to be used as a ridge tile or ridge accessory.

Its longitudinal direction consists of four tiles 8 longitudinally fitter together.

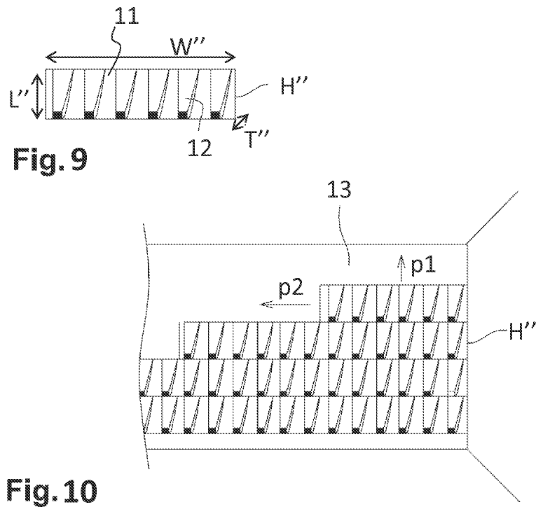

FIG. 9 shows another example of a hydrophobic covering element H″, with a width “W″” length “L″” and thickness “T″”, viewed from above. The hydrophobic element H” comprises a visible front 11 comprising a relief 12 consisting of a spindle shape repeated six times.

FIG. 10 shows the placement of hydrophobic elements H″ on a surface 13 formed by a wall. The hydrophobic elements H″ are those shown in FIG. 9. A plurality of hydrophobic elements H″ are already placed on the wall 13 for example using glue. The arrows p1 and p2 in FIG. 10 indicate the direction of placement in order to finish completely covering the wall 13.

1. Method for manufacturing a hydrophobic covering element, characterised in that it comprises the following steps:
a) preparation of a mixture of water and of organic material coming from sustainably renewable resources;
b) moulding of the mixture prepared in step a) in order to obtain a moulded element,
c) drying and densification of the moulded element obtained in step b) in order to obtain a dried and densified element,
d) full impregnation of the dried and densified element obtained in step c), in a binder composed of organic materials coming from the resources that are sustainably renewable in order to obtain a hydrophobic covering element.

2. Method according to claim 1, characterised in that the step c) of drying and densification is carried out by a pressing system comprising at least a pressing mould and counter-mould pair.

3. Method according to claim 2, characterised in that the mould and counter-mould pair is placed under a depression, while being heated, and the mould and counter-mould are pressed against one another.

4. Method according to claim 2, characterised in that the pressing system comprises a plurality of pressing mould and counter-mould pairs, the pairs being disposed in a circle and capable of moving by rotation of said circle.

5. Method according to claim 1, characterised in that step c) comprises an additional drying in a hot air or infrared or microwave or high-frequency oven.

6. Method according to claim 1, characterised in that the binder comprises an organic material, coming from the resources that are sustainably renewable, in liquid form between 20 and 150° C. or of a mixture of organic materials coming from the resources that are sustainably renewable, the mixture being in liquid form between 20 and 150° C.

7. Method according to claim 1, characterised in that the binder is a plant binder composed of derivatives of Tall-oil, such as Tall-oil pitch.

8. Method according to claim 1, characterised in that it comprises an additional step e), involving coating the hydrophobic element obtained in step d) with a coating.

9. Method according to claim 8, characterised in that the coating is one or more layers of a finishing material, like a paint, chosen from the group comprising materials containing mineral pigments and mineral fillers, biosourced organic pigments coming from the resources that are sustainably renewable, materials containing plant resins coming from biomass, materials containing synthetic resins.

10. Method according to claim 8, characterised in that a fireproofing and/or hydrophobic treatment is carried out in step a) and/or during step e).

11. Hydrophobic element for covering at least a portion of a surface, such as a wall and/or a ceiling and/or a surface in contact with the outside, said element having a developable or non-developable shape and comprising a back in contact with said surface and a visible front, characterised in that it comprises more than 90%, and preferably more than 99%, organic material coming from sustainably renewable resources.

12. Hydrophobic element according to claim 11, the visible front of which is capable of having a relief with a decorative appearance.

13. Use of the hydrophobic covering element according to claim 11, for the covering of at least a portion of a surface in contact with the outside, such as roofing or cladding.

14. Use of a hydrophobic covering element according to claim 11, as a decorative object chosen in particular from the group comprising friezes, complaints, mouldings, decorative panels.

15. Use of the hydrophobic covering element prepared according to claim 1 for the covering of at least a portion of a surface in contact with the outside, such as roofing or cladding.

16. Use of a hydrophobic covering element prepared according to claim 1 as a decorative object chosen in particular from the group comprising friezes, complaints, mouldings, decorative panels.
